(19) United States
(12) Patent Application Publication
(10) Pub. No.: US 2008/0165294 A1
(43) Pub. Date: Jul. 10, 2008

(54) Modular in wall display system and method

(76) Inventors: Charles Chia-ming Chuang, Shanghai (CN); Joseph Marc McConnaughey, Shanghai (CN)

Correspondence Address: THELEN REID BROWN RAYSMAN & STEINER LLP, P.O. BOX 640640, SAN JOSE, CA, 95164-0640, US

(21) Appl. No.: 11/964,039

(22) Filed: Dec. 25, 2007

Related U.S. Application Data
(60) Provisional application No. 60/883,508, filed on Jan. 4, 2007.

(51) Int. Cl. H04N 5/64

(52) U.S. Cl. 348/839; 348/E05.129

(57) ABSTRACT

A modular display system for in wall application comprises a display module and a mechanical support interface module with power connection.

### CROSS REFERENCE TO RELATED APPLICATIONS

This application claims priority to and incorporates by reference U.S. Patent Application No. 60/883,508 filed Jan. 4, 2007 by inventors Charles Chuang et al.

### FIELD OF THE INVENTION

The present invention relates to modular display system for in wall application and, in particular, but not exclusively, provides a large format display system and method for installation in internal partition walls or exterior walls installation.

### BACKGROUND OF THE INVENTION

The demand for high resolution large displays is increasing every year according to market research firms. High Definition (HDTV) and the emergence of Internet Protocol Television (IPTV) are the stimulus for such growth. However, displays of 50″ or more present a problem for small rooms. Front projection display has a very flat profile and light weight, however, most consumers cannot accept that the ambient lighting significantly degrades projection performance and dimmed ambient interferes with daily activities. 50″ plasma displays are very heavy, about 100 kg, that cannot be hanged on the wall easily, and 50″ Liquid Crystal Display (LCD) displays are much more expensive than competing technologies. Rear projection displays have good performance under ambient lighting, only weights about 30 kg for a 50″ display, but its product depth, typically 18″ or more, won't fit in small rooms. Clearly the current situation is limiting the growth of large format displays.

It is desirable to have a display right in the structure of a partition wall or an exterior wall. Having the display off the floor means even small rooms can fit. It is desirable to have a mechanical support structure that is easy to design into a new house or to retrofit into an existing room. It is desirable to preserve the ease of installation and service of an in wall display. It is also desirable to have a method that allows different choices of technology for such an in wall displays. It is desirable to have a swivel base build-in so a display can be swiveled for viewing at different angles and at different rooms.

### SUMMARY OF THE INVENTION

Embodiments of the invention provide a display system that can be used for in wall application; a mechanical support interface and a method of construction that allows in wall displays; and an in wall display on an exterior wall that can be swiveled for indoor or outdoor use.

In an embodiment, an interface system, comprises a mount and a rotating coupling mechanism coupled there. The mount is adapted for insertion into and securing to a wall. The wall has a first and a second opening on opposing surfaces. The mount has an electrical interface for power connection to a projection display. The rotating coupling mechanism couples the projection display to the mount so that the display can be rotated to face either the first or second opening of the wall.

A method of installing a display into a wall, comprises: opening a hole through a wall such that the wall has two openings, one per side; installing a mount into the hole, the mount having a rotating coupling mechanism for coupling a projection display to the mount so that the display can be rotated to face either the first or second opening of the wall, the mount having at least an electrical interface for power connection to the display; mounting an outer shell of the display onto the mount, the outer shell having a mirror therein; coupling a set rails to the shell, the set of rails adapted for a screen to ride thereon; sliding the display on the rails to cover at least a portion of the hole; coupling an assembly to the outer shell, the assembly having a power supply, light engine and video processing board, the video processing board having an automatic alignment system; and installing a front panel with speakers into the hole.

The foregoing and other features and advantages of illustrated embodiments of the present invention will be more readily apparent from the following detailed description, which proceeds with reference to the accompanying drawings.

### BRIEF DESCRIPTION OF THE DRAWINGS

FIG. 1 is a block diagram illustrating an embodiment of an in wall display system.

FIG. 2 is a block diagram illustrating the front bezel and the rear cover of an embodiment.

FIG. 3 is a block diagram illustrating front flanges and rear flanges of an embodiment.

FIG. 4 is a block diagram illustrating the swivel function of an embodiment of in wall display.

FIG. 5 is a block diagram illustrating an assembly method of an embodiment of an in wall display.

FIG. 6 shows the assembly diagram of an embodiment of an in wall display.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

Mechanical Support Interface Module

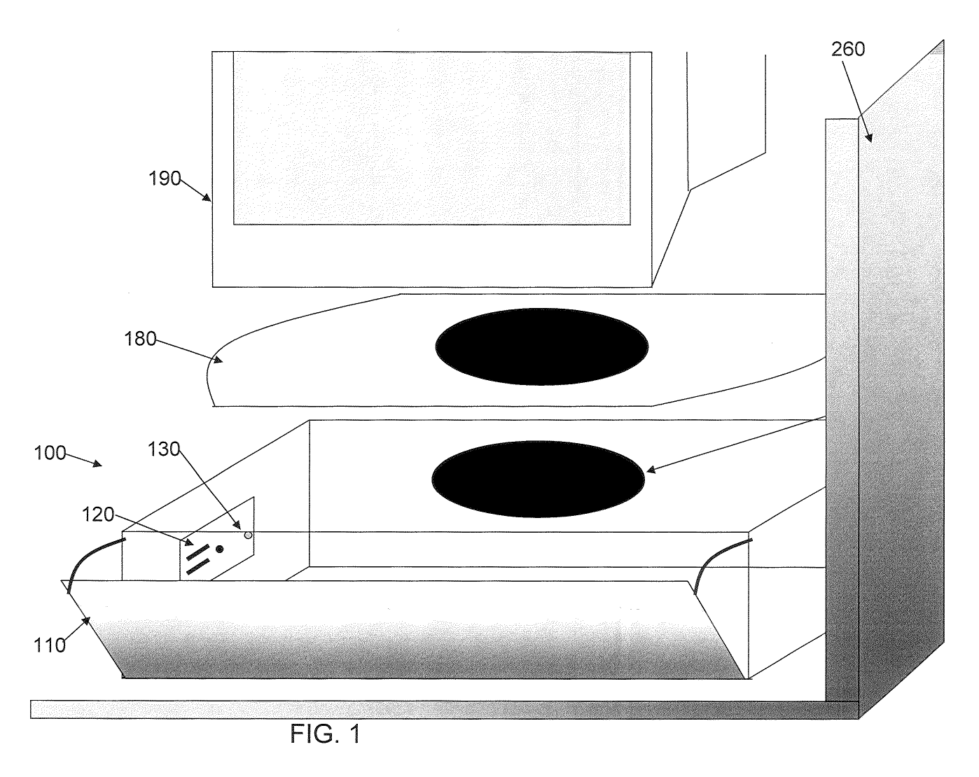

FIG. 1 is a block diagram illustrating an embodiment of an in wall display system. A mechanical support interface module 100 is positioned below a display 190 and secured to a wall 260 so as to support the weight of the display 190. The width and height of this mechanical support interface module 100 is known so a construction method similar to that of a window in a wall can be made. In another embodiment, this mechanical support interface module 100 can be placed on top of the display 190 and secured to the wall from the top. A wall outlet 120 with AC power can be constructed easily on the inside surface of this mechanical support interface module 100 using a wall outlet construction method. A television signal input 130 (e.g., RF or cable terminal) can also be constructed the same way. By the same token, a networking connector can also be placed in addition or instead of the signal input 130. A hole on top of the mechanical support interface module 100 is big enough to thread through a power cable(s), a video cable(s), an audio cable(s), and/or other input/output interface cables down from the display 190. A front cover 110 can be flipped down for the power cord and cable connection to the display 190 in the installation process. An optional rotation mechanism 180, commonly known as a “Lazy Susan” can be installed, in one embodiment, in between the display and the mechanical support interface module to facilitate the rotation of the display. An electric motor can also be mounted to automatically swivel the display. Mechanical rotation limits can be designed to only one turn to prevent the display from rotating continuously and damage the power and cable connections through the rotation mechanism. This mechanical support interface module can be enlarged so a wireless keyboard and mouse transmitter and receiver can be enclosed (not shown) to support wireless keyboard/mouse operation. The mechanical support interface module can also enclose a DVD player, a computer, a game player, an audio amplifier, or other devices (not shown) that are commonly hooked up with a display.

Front and Rear Covering

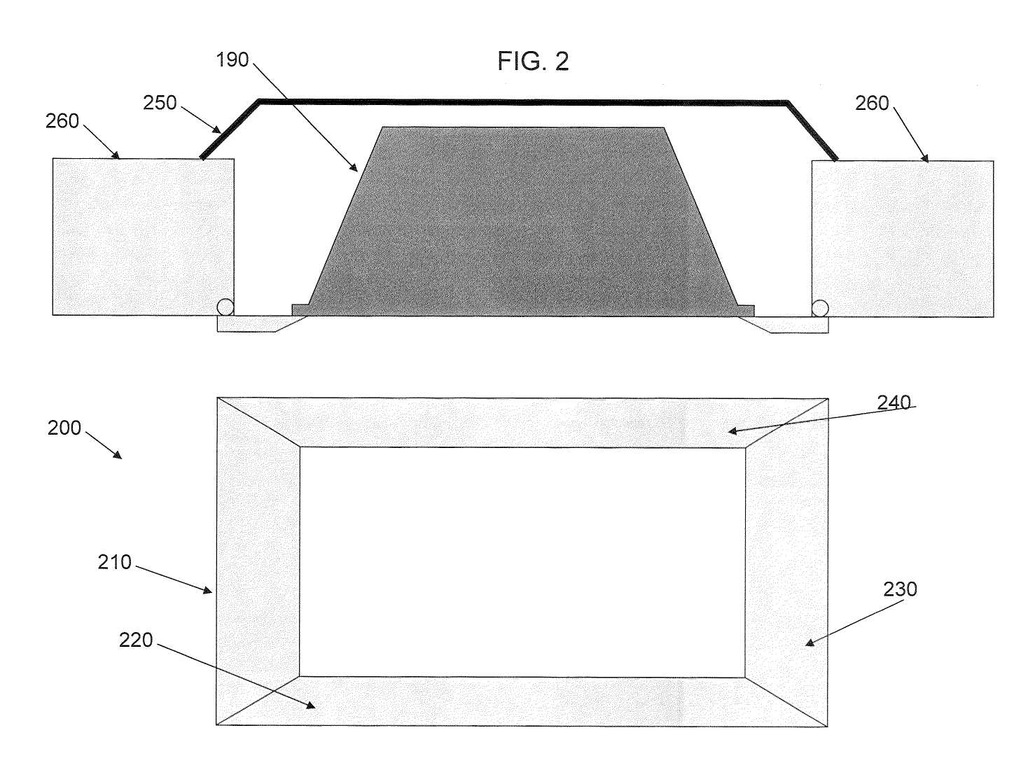

FIG. 2 is a block diagram illustrating the front bezel and the rear cover of an embodiment. The front covering or the front bezel 200 of the illustrated embodiment comprises four separate pieces 210, 220, 230, 240 and is shaped like a picture frame. The front covering 200 is a decorative piece to cover up the gap in between the display 190 and the wall 260 and can be shaped like edges of a window or any other decorating themes. The rear covering 250 is for decoration as well as dust prevention and ventilation. The rear covering 250 also serves as environmental shield if it is an exterior wall. In an embodiment the rear covering (bezel) 250 is coupled to the wall 260. In another embodiment, the rear covering 250 is coupled to the display 190 or the rotation mechanism 180 such that rotation of the display 190 also rotates the rear covering 250 in synchronization.

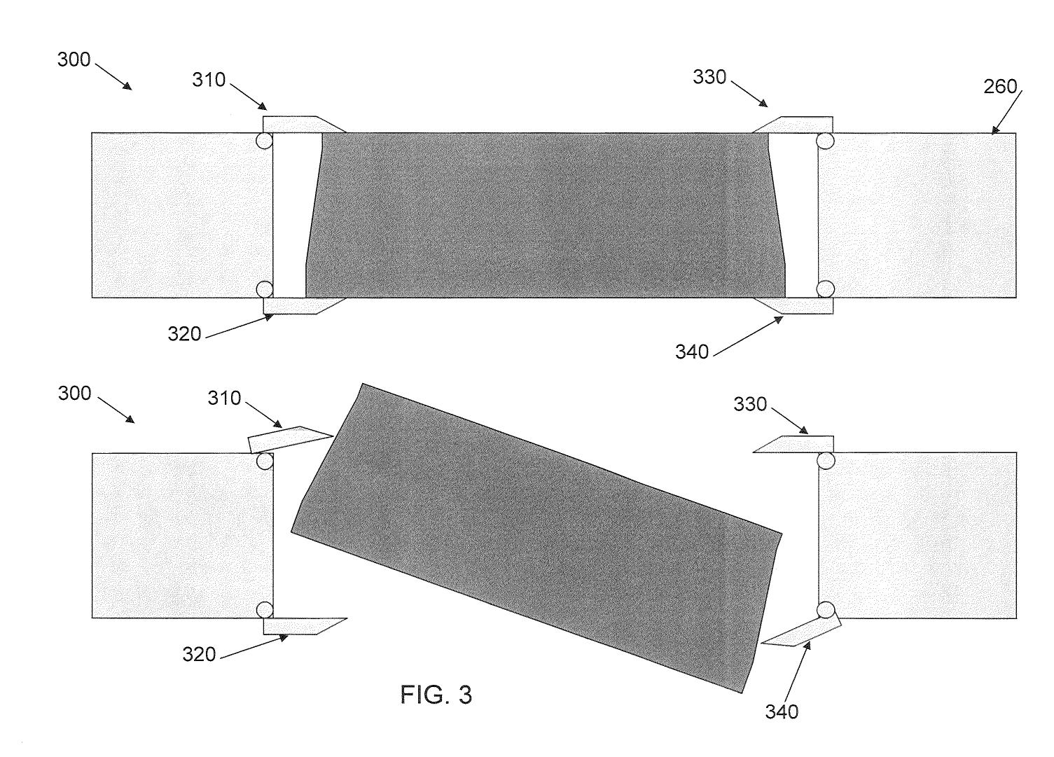

FIG. 3 is a block diagram illustrating a plurality of flanges (front flanges 320, 340 and the rear flanges 310, 330) of an embodiment where the display 190 can be swiveled to face either opening. As shown in FIG. 3 the flanges 310-340 are spring loaded and can deflect away as the display 190 is turned and will spring back to normal position once the display 190 is properly positioned to either the rear or the front face of the wall 260. The flanges 310-340 are also beveled on one or more sides in an embodiment.

Solution for Swivel Display at Different Floor Height

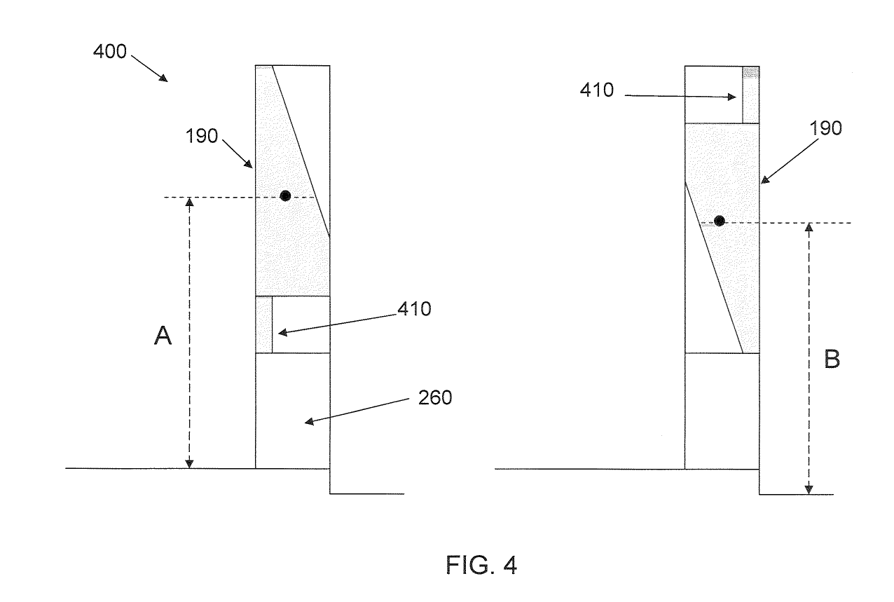

FIG. 4 is a block diagram illustrating the swivel function of an embodiment of in wall display with swivel axis turned 90 degrees. In order to place the display 190 at the right height for different floor height at two sides of a wall 260, distance A must equal to B. A filler plate 410 is used with the display 190 to correct for this difference in floor height around the swivel axis.

Solution for Custom Size Displays

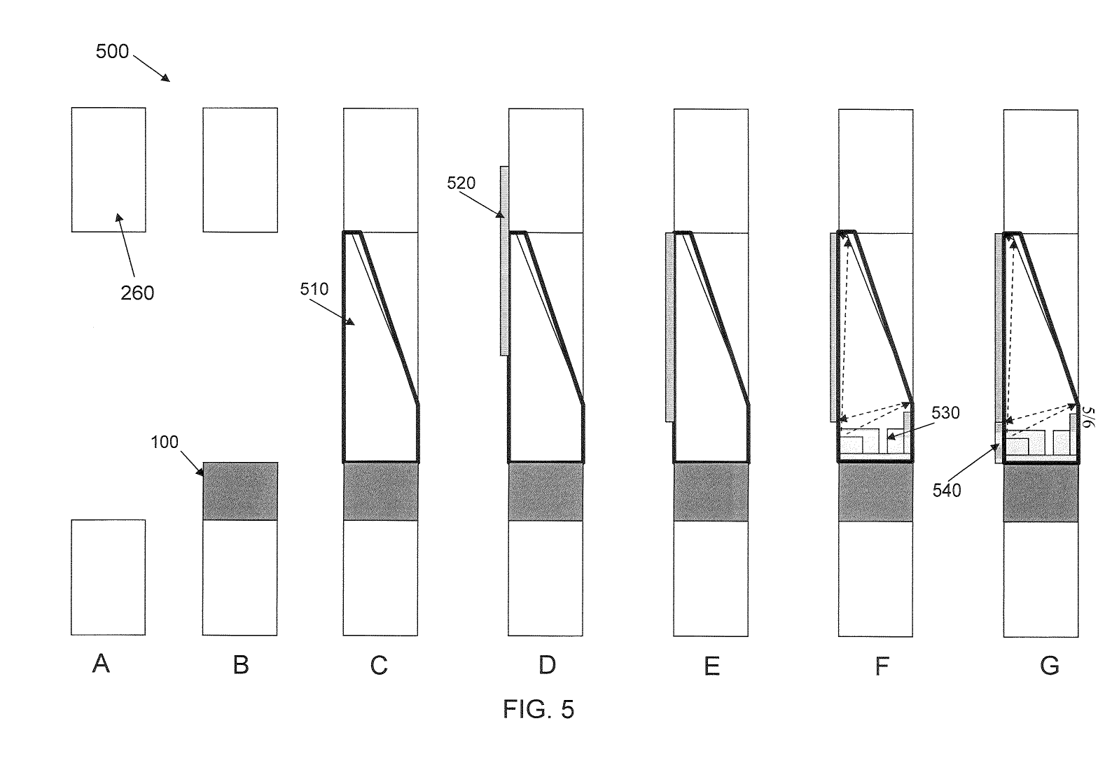

Often times the desired display size is not available. Plasma Display Panel (PDP) and LCD displays only have fixed discrete sizes from panel factories. Rear projection displays is a good solution since the size is adjustable by varying the distance to the screen. However, the construction and design of such a rear projection display need to be refined to fit this application. FIG. 5 is a block diagram illustrating the assembly method of a embodiment of an in wall display using a custom sized projection display.

The method comprises:

A: Correct opening on a wall 260 is opened.

B: The mechanical support interface module 100 (e.g., mount) is installed.

C: The outer shell of the projection display 510 with mirror inside is installed.

D: A display screen 520 on rails that can slide up and down is installed

E: The display screen is slid in position

F: A monolith 530 with power supplies, light engine and video processing board is installed from the rear. At this time, an automatic alignment system is used to align the system to achieve proper display performance specifications.

G: A lower front panel with speakers is installed.

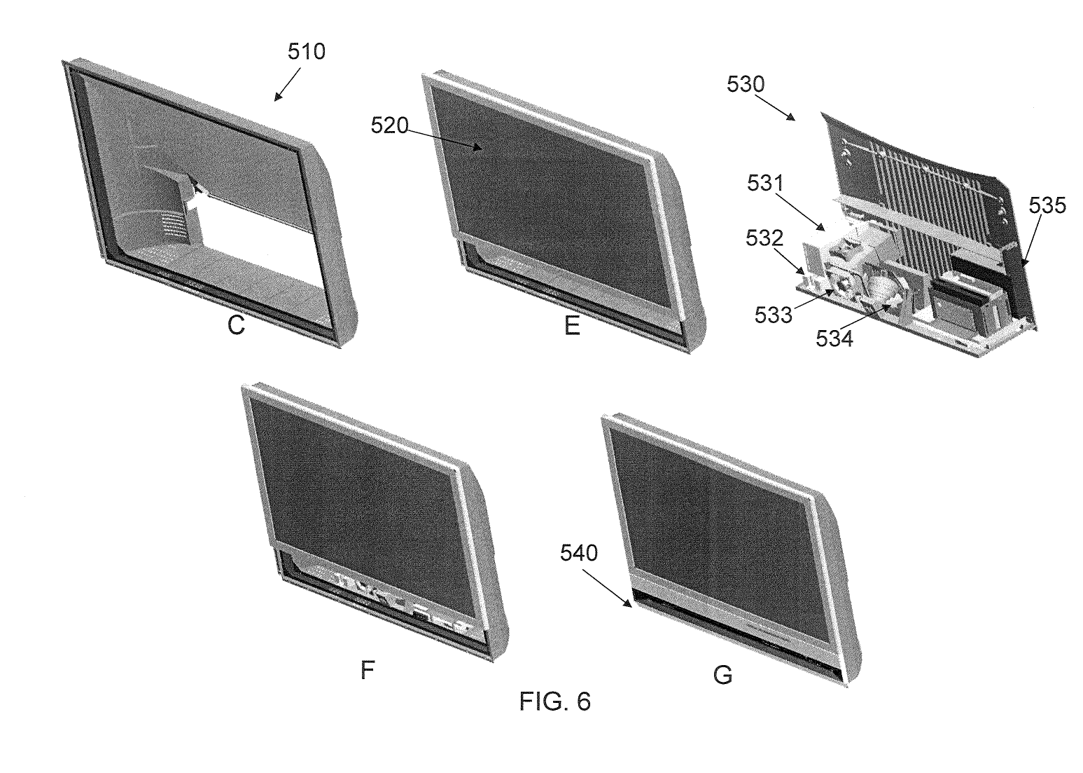

FIG. 6 shows a perspective view of the custom size projection display and the details on the monolith 530. A power supply 531 for the display is positioned on top of the ballast for the lamp 532. The lamp 533 and the light engine 534 is positioned near the center of the monolith. 535 shows the television/video processing circuits.

The foregoing description of the illustrated embodiments of the present invention is by way of example only, and other variations and modifications of the above-described embodiments and methods are possible in light of the foregoing teaching. For example, PDP and LCD displays could be used as display of choice. Connections may be wired, wireless, modem, etc. The embodiments described herein are not intended to be exhaustive or limiting. The present invention is limited only by the following claims.

What is claimed is:

1. An interface system, comprising:
a mount adapted for insertion into and securing to a wall, the wall having a first and a second opening on opposing surfaces; the mount having at least an electrical interface for power connection to a projection display; and
a rotating coupling mechanism for coupling the projection display to the mount so that the display can be rotated to face either the first or second opening of the wall.

2. The interface system of claim 1, further comprising a front bezel for coupling to the display adapted so that a gap between the display and the wall is not visible to a viewer.

3. The interface system of claim 1, further comprising at least one flange biased to secure the display facing one of the openings.

4. The interface system of claim 3, wherein the at least one flange is beveled such that less force is required to rotate the display to face one of the openings than to rotate the display from facing one of the openings.

5. The interface system of claim 3, wherein the at least one flange is spring loaded.

6. The interface system of claim 1, further comprising a bezel positioned to a rear of the display and to cover an opening other than an opening that the display is facing.

7. The interface system of claim 1, further comprising a filler plate positioned adjacent to the display, wherein the display rotates around a horizontal axis to face the openings such that the filler plate fills in a gap between the wall and display when facing either opening and the display faces a viewer at the same height despite a difference in display centering at the two openings.

8. A method of installing a display into a wall, comprising:
opening a hole through a wall such that the wall has two openings, one per side;
installing a mount into the hole, the mount having a rotating coupling mechanism for coupling a projection display to the mount so that the display can be rotated to face either the first or second opening of the wall, the mount having at least an electrical interface for power connection to the display;
mounting an outer shell of the display onto the mount, the outer shell having a mirror therein;
coupling a set rails to the shell, the set of rails adapted for a screen to ride thereon;
sliding the display on the rails to cover at least a portion of the hole;
coupling an assembly to the outer shell, the assembly having a power supply, light engine and video processing board, the video processing board having an automatic alignment system; and
installing a front panel with speakers into the hole.

9. The method of claim 8, further comprising coupling a front bezel to the display so that a gap between the display and the wall is not visible to a viewer.

10. The method of claim 8, wherein the mount comprises at least one flange biased to secure the display facing one of the openings.

11. The method of claim 10, wherein the at least one flange is beveled such that less force is required to rotate the display to face one of the openings than to rotate the display from facing one of the openings.

12. The method of claim 10, wherein the at least one flange is spring loaded.

13. The method of claim 8, further comprising mounting a bezel to a rear of the display and to cover an opening other than an opening that the display is facing.

14. The method of claim 8, further comprising positioning a filler plate adjacent to the display, wherein the display rotates around a horizontal axis to face the openings such that the filler plate fills in a gap between the wall and display when facing either opening and the display faces a viewer at the same height despite a difference in display centering at the two openings.
